(19) United States
(12) Patent Application Publication
(10) Pub. No.: US 2004/0095066 A1
(43) Pub. Date: May 20, 2004

(54) Electric lamp with insulating base with improved vibration resistant supports

(76) Inventors: Mitchell R. Gagnon, Hooksett, NH (US); Arnold R. Cernota, Greenfield, NH (US); Douglas A. Bougher, West Lebanon, NH (US)

Correspondence Address: OSRAM SYLVANIA Inc., 100 Endicott Street, Danvers, MA, 01923, US

(21) Appl. No.: 10/300,522

(22) Filed: Nov. 20, 2002

(51) Int. Cl. H01K 1/50

(52) U.S. Cl. 313/578

(57) ABSTRACT

Electric lamp assembly comprising a sealed, light-transmitting envelope having a preferably generally spherical or bulbous portion and a press seal, a filament in the interior of the bulbous portion, the filament having a pair of electrical leads sealed within the press seal and extending exteriorly therefrom. The bulbous portion also includes at least one elongated member such as a lead normally present for a second filament of a double filament lamp, preferably two such members, but is devoid of the second filament. The elongated member or members also are sealed in the press-seal, and help provide stability to the assembly.

### BACKGROUND OF THE INVENTION

The present invention relates to incandescent lamps typically used in automotive applications, and particularly to signal lamps for automobiles.

Conventional S-8 style incandescent lamps have a spherical bulb with a press seal. The bulb has a diameter of about 1 inch, and is generally made of SG10 type glass, although other glasses, such as unleaded glass, may be used. The filament housed in the bulb is supplied with electricity through leads sealed through the press seal. Lamps with single filaments with two leads, and lamps with double filament with four leads, are common. A base is attached to the press seal that provides a mechanical coupling and electrical connection for the lamp when inserted within a corresponding socket component. The leads extend out of the press seal and are maintained in proper alignment on the outer surface of the base to facilitate contact between the leads and contacts in the corresponding socket.

The S-8 wedge single filament stop lamps have been sold in North America for over fifteen years. However, entry into the European market has been difficult due to strict customer requirements. For example, low wattage and good vibration resistant characteristics are important criteria to original equipment manufacturers in Europe. Indeed, existing single filament S-8 designs meeting the low wattage requirements, for example by using smaller diameter filament wire, do not pass the IEC 810 WBR vibration profile necessary to obtain customer acceptance and approval in Europe. Specifically, it was found that the European WBR test vibration profile focused around the resonance frequency of the lamps filament, resulting in filament failures.

It therefore would be desirable to provide a cost-effective incandescent lamp suitable for automotive applications that exhibits low wattage yet meets the required vibration profile necessary to pass strict customer standards.

### SUMMARY OF THE INVENTION

The problems of the prior art have been overcome by the present invention, which provides an electric lamp assembly comprising a sealed, light-transmitting envelope having a preferably generally spherical or bulbous portion and a press seal, a filament in the interior of the bulbous portion, the filament having a pair of electrical leads sealed within the press seal and extending exteriorly therefrom. The bulbous portion also includes at least one elongated member such as a lead normally present for a second filament of a double filament lamp, preferably two such members, but is devoid of the second filament. The elongated member or members also are sealed in the press-seal, and help provide stability to the assembly. The present invention also includes within its scope such an electric lamp assembly that includes an insulating base member that maintains the operative leads in proper alignment for insertion into a corresponding socket component.

Thus, in a preferred embodiment, the present invention provides a single filament lamp assembly that takes advantage of the structural rigidity provided by a double filament mount. A single filament lamp that meets strict vibration profile requirements is obtained.

### BRIEF DESCRIPTION OF THE DRAWINGS

FIG. 1 is a perspective view of the lamp in accordance with the present invention;

FIG. 2 is a front view of the lamp without the insulating base attached, in accordance with the present invention; and

FIG. 3 is a perspective view of a base member for a lamp in accordance with the present invention.

### DETAILED DESCRIPTION OF THE PRESENT INVENTION

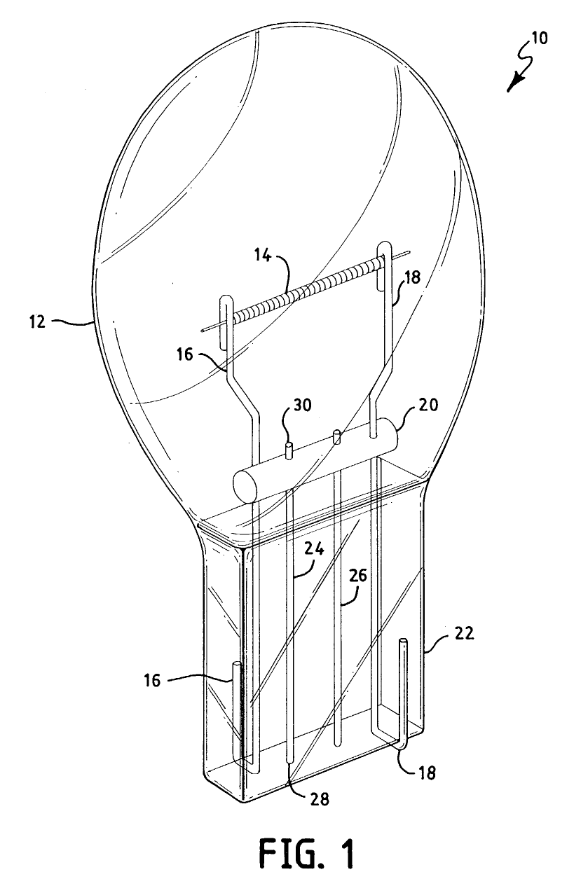

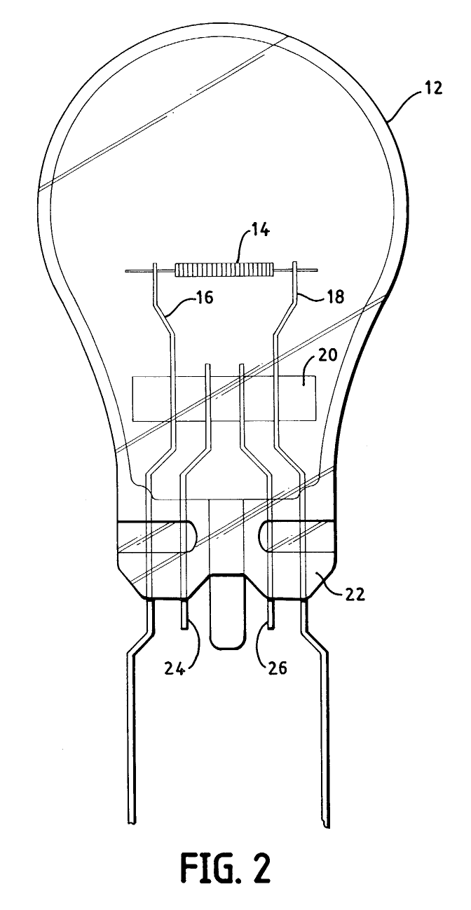

Turning now to FIGS. 1 and 2, there is shown generally at 10 a lamp particularly suitable for use in a signal assembly in an automobile. Lamp 10 includes a bulbous portion 12 preferably made of glass. The particular shape of the bulbous portion 12 is shown as spherical, although other shapes, including tubular, are within the scope of the present invention. The bulbous portion is a light transmitting envelope that contains a gas, conventionally a rare gas such as argon at atmospheric pressure. Also contained in bulbous portion 12 is a filament 14. The filament 14 can be coiled and comprised of tungsten, for example. Opposite end regions of filament 14 are connected to and supported by spaced lead-in conductors 16, 18, each of which extends through bridge 20 as shown. Bridge 20 is preferably made of glass. The lead-in conductors 16, 18 may be bent as illustrated FIG. 1 to enable proper positioning of the filament 14 within the glass envelope. They are electrically conductive and are preferably composed of a metallic alloy, such as dumet. The lead-in conductors are hermetically sealed in press seal 22 formed at the lower end of the lamp assembly 10. The press seal 22 can be formed by a pressing operation well known in the art. The elongated lead-in conductors 16, 18 project through the press seal 22 where they are available for connection to an electricity source.

To improve the structural rigidity of the lamp assembly 10, a double lead filament support can be used while omitting a second filament. Specifically, an elongated member 24, such as an inner minor lead, preferably two such elongated members, 24, 26 are contained in the lamp assembly 10. The elongated member(s) 24, 26 enter the bridge 20 and extend into the glass press seal 22. The member(s) are trimmed both at first free end 28 at the bottom of the press seal 22 after the press operation, and at second free end 30 directly above or at a higher length to the bridge 20. The member(s) 24 thus are held at one end by bridge 20 and at the opposite end by being sealed through the bottom of the press seal 22 and thereby remain stable in the bulbous portion 12, mostly in the press seal 22, for press stability. The elongated member(s) 24 were found to change the resonance frequency characteristics of the lamp away from the European WBR profile.

In the embodiment of FIG. 2, two spaced elongated members 24, 26 are shown, with member 24 positioned inwardly of the lead-in conductor 16, and member 26 positioned inwardly of lead-in conductor 18. Although this positioning of the members 24, 26 is preferred, it is within the scope of the present invention to position one or the other of the member(s) 24, 26 outwardly of its respective adjacent lead-in conductor. It also is within the scope of the present invention to position the one or more member(s) 24 at an angle other than perpendicular to the longitudinal axis of the bridge 20.

Preferably lead-in conductors are used as the elongated member(s) 24, since they have been found to have the appropriate characteristics necessary to enhance the vibration profile of the single filament lamp. In addition, this enables constructing the assembly by utilizing double filament lamp mounts and modifying the mount simply by eliminating the second filament, for example the minor filament, and trimming the minor leads. However, those skilled in the art will appreciate a similar result can be achieved by predetermining the size of the elongated member(s) 24 sufficient to improve the structural rigidity of the assembly and constructing the assembly using such member(s). In this embodiment, it is not necessary that the second free end 30 extend above the bridge 20 or that first free end 28 extend below (and out of) press seal 22, as long as the elongated member(s) 24 are secured in place in the lamp.

In addition, since the elongated member(s) 24, 26 are not functioning as electrical conductors and are thus not true “leads”, they need not be made of electrically conductive material. Any material that can provide the required structural rigidity and not interfere with the operation of the lamp assembly can be used, as long as the material matches the glass expansion rates.

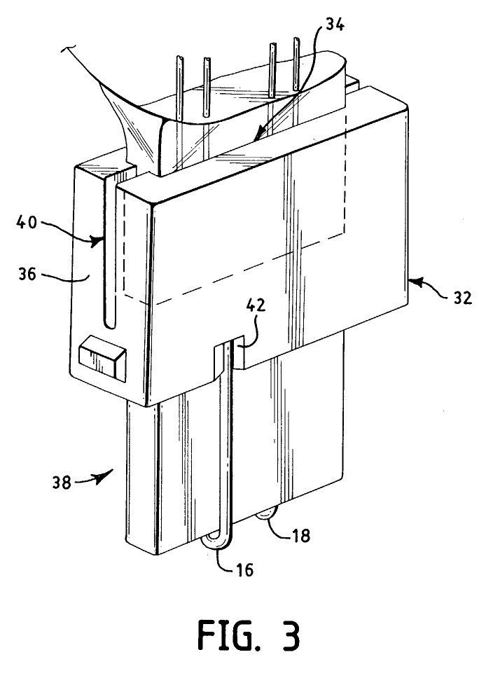

In a preferred embodiment, the lamp assembly of the invention includes an electrically insulating base member 32 such as that shown in FIG. 3. The base member 32 has an elongated opening 34 extending into a first portion 36 that securely receives the flattened press seal 22. Preferably two elongated slots 40 are formed along the sides of the base member 32 to allow for flexibility so that the sidewalls expand outwardly during insertion of the press seal 22. A protruding second portion 38 of the base member is configured to be received by a corresponding socket (not shown), and includes bottom apertures out of which the operative lead-in conductors extend for electrical contact in the socket. The lowermost portion of the first portion of the base member 32 can be formed with channels 42 on opposite sides, each channel 42 being designed for having one of the terminal ends of the lead-in conductors 16, 18 inserted and securely retained therein.

For ease of manufacture, the lamp of the present invention can be constructed as if it were a dual filament lamp. Thus, a set of cutting tools cuts the minor elongated members (s) 36 above the bridge 20. The tools are narrow and thin so the major filament support is not damaged. Another set of cutting tools cuts the lower elongated member(s) 24, 26 directly below where the glass press will be. Alternatively, the lower elongated member(s) 24, 26 can be trimmed below the glass press seal once the lamp is fully constructed.

In a working example of an S8 lamp the conductors were made of a round nickel iron ally having a diameter of 0.508 millimeters. The two elongated support members were formed form the same material and had the same diameter. The support members extended approximately 3.81 millimeters from the press seal to the bridge. The support members were offset inwards from the conductors by 2.921 millimeters. The relatively thick, short, metal support members were substantially rigid when fixed in the press seal. They helped stop the bridge from independent motion, and thereby limited detrimental harmonic vibration of the filament. The bridge, envelope, filament and other features were substantially the same as in a standard single filament S8 lamp. The lamps were tested by being held in various orientations on a vibrating table during operation. The table was vibrated from 12 Hz to 1002 Hz. Vibration of the filament was monitored to determine harmonic response to the table vibrations. Testing of similar lamps without the support members showed filament vibration in the 1250 Hz to 1700 Hz range. The lamps with the additional support members, otherwise similar, and tested in the same fashion showed no filament displacement. The result of the testing indicated that the addition of the support members eliminated filament movement in the Hz range that is common in automobile applications. The relatively short and stiff support members are substantially rigid and thereby increase the lamps resistance to vibration, resulting in lamps with lower failure rates, and more consistent optical performance, so as to comply with the requests from automotive manufactures.

What is claimed is:

1. A lamp assembly, comprising:
a light-transmitting envelope;
a bridge;
a filament in electrical contact with a pair of spaced lead-in conductors;
a press seal, said lead-in conductors passing through said bridge and being sealed in said press seal and projecting exteriorly of said press seal; and
at least one substantially rigid, elongated support member entering said bridge and extending into said press seal, said elongated support member having opposite free ends.

2. The lamp assembly of claim 1, further comprising a second elongated support member entering said bridge and extending into said press seal, said second elongated support member being spaced from said first elongated support member.

3. The lamp assembly of claim 2, wherein said second elongated support member has opposite free ends.

4. The lamp assembly of claim 1, further including an electrically insulating base.

5. A double filament mount for a single filament lamp assembly, said lamp assembly comprising a light-emitting envelope having a press seal, said double filament mount comprising:
a pair of spaced leads in electrical contact with said single filament, said pair of spaced leads extending through a bridge and being hermetically sealed in said press seal and projecting exteriorly of said press seal;
a pair of spaced apart, substantially rigid elongated members each having opposite free ends, each said elongated member extending out of said bridge and into said press seal.

6. The lamp assembly of claim 4, further including an electrically insulating base.

7. An electric lamp comprising:
a sealed, light-transmitting glass envelope having a bulbous portion and a press seal;
a filament located within the interior of said bulbous portion of said envelope;
a first pair of lead-in conductors each connected at one end thereof to said filament, each of said conductors sealed within said press seal of said envelope and projecting exteriorly thereof; and
a second pair of lead-in conductors the members of which second pair are adjacent to the respective members of said first pair, each of said second conductors of said second pair being substantially rigid and sealed within said press seal of said envelope and unconnected to any filament.

8. The electric lamp of claim 7, further comprising an electrically insulating base member including a first portion having an opening therein and a protruding second portion adjacent said first portion for being positioned within a socket having electrical contacts therein, said press seal of said envelope being securely positioned within said opening, said first portion of said base member thereby providing a cover for said press seal, each of said exteriorly projecting portions of said conductors of said first pair of lead-in conductors passing through said protruding second portion and protruding externally thereof.
